(19) United States
(12) Patent Application Publication
(10) Pub. No.: US 2012/0116859 A1
(43) Pub. Date: May 10, 2012

(54) Method and System for Point of Sale Online Coupon Management

(75) Inventor: Matthew Bone, Chicago, IL (US)

(73) Assignee: COUPONCABIN, INC., Chicago, IL (US)

(21) Appl. No.: 12/940,667

(22) Filed: Nov. 5, 2010

(51) Int. Cl. G06Q 30/00

(52) U.S. Cl. 705/14.23

(57) ABSTRACT

An online coupon system may provide retailers with the ability to process and track online coupons displayed on personal computing devices at the point of sale without using sophisticated electronic input, image recognition devices, or other input devices. A customer may present a coupon displayed on a computing device with an active network connection. Using the computing device, the retailer may validate or activate the coupon. Activating the coupon may then send a message to a back end server that processes and tracks the discount for the retailer.

### TECHNICAL FIELD

The present disclosure generally relates to a system and method for managing online discounts and, more particularly, for managing point of sale coupons within an online system.

### BACKGROUND

Store front, “brick-and-mortar” based retailers have employed various methods to draw shoppers to stores. One method is the use of discounts in the form of physical coupons. Physical coupons are offered to a potential customer through printed circulars, newspaper supplements, magazine advertisements, etc., and usually offer some sort of discount off of the regular sale price of an item. Bar codes or other identification marking on the printed coupons allow the retailer and the manufacturer to track various information about the sale including the origin of the printed coupon (i.e., the newspaper, magazine, or other physical source of the coupon). By tracking information about the source of the coupon, the retailer or manufacturer may also provide a commission from the sale of the item to the coupon publisher as motivation to publish future coupons.

Coupons are also used in online sales transactions. Like printed coupons, sales commissions may be earned by entities that publish, aggregate, and maintain online coupon codes or discount URLs or “links” through affiliate marketing. One example of an online coupon system includes U.S. patent application Ser. No. 11/746,384 entitled “System and Method for Sharing Revenue Resulting from Online Coupon Use” filed on May 9, 2007, the entire disclosure of which is incorporated by reference herein. In an affiliate marketing relationship, a retailer or other online business rewards one or more third parties or “affiliates” for a sales transaction that originates from the affiliate's marketing efforts.

Typically, an online customer visits an affiliate's website (e.g., CouponCabin.com) by entering the affiliate's URL directly into the customer's browser, by a search engine, by following a link in an email, etc. The customer may find a discount link or coupon code for a retailer and then select or click that link or code that includes a request URL. Selecting the link or coupon sends the customer's browser to the affiliate network's server along with an identifying code contained in the request URL indicating that the affiliate was the referral source. The affiliate network's server/redirector sets a cookie on the customer's computer that identifies the affiliate and the affiliate network to the retailer. The customer's browser then redirects to the retailer's web site. The customer shops at the retailer's site, and as part of the checkout process, the customer may enter the coupon code in an appropriate field. Upon completion, the sale is logged to a server at the affiliate network and the affiliate network reports the completed transaction back to its source: the affiliate. The affiliate may earn a percentage commission on the sale according to terms agreed to with the retailer because the retailer was able to identify the affiliate from the information contained in the cookie.

While online coupons are particularly useful for web-based transactions due to the affiliate marketing network, online coupons have not been used extensively in a “brick-and-mortar” setting. While ubiquitous cellular phones and other personal web-enabled devices have made it relatively easy to display online coupons during checkout in a retail setting, retailers have not fully embraced using online coupons due to various technological complications. In particular, smaller retail stores lacking sophisticated bar scanners, image recognition devices, and other computer input devices cannot process and track online coupons, even if the coupon is easily displayed on a customer's personal device.

Lacking such equipment, an employee could personally track each coupon as it was presented at checkout and personally discount each coupon-related transaction. However, having no physical coupon or other method to match with each potentially discounted sale, an employee could fraudulently associate a displayed coupon with a sale in which the customer did not actually present the coupon. Because the customer paid full price, the employee could record the transaction as including the coupon and steal the coupon amount. Having no reliable and accurate method to track online discounts in retail environments lacking technological solutions to do so, online coupons that are capable of being presented on personal network-enabled devices are difficult to use for small retailers and generally used by large, sophisticated retailers with the capability to electronically process an online coupon at the point of sale from a customer's personal device.

### SUMMARY

An online coupon system may provide retailers with the ability to process and track online coupons displayed on personal computing devices at the point of sale without using sophisticated electronic input, image recognition devices, or other input devices. A customer may present a coupon displayed on a computing device with an active network connection. Using the computing device, the retailer may validate or activate the coupon. Activating the coupon may then send a message to a back end server that processes and tracks the discount for the retailer.

### BRIEF DESCRIPTION OF THE DRAWINGS

FIG. 1 illustrates an exemplary block diagram of a computer network and system on which an exemplary customer registration and coupon distribution system and method may operate in accordance with the described embodiments;

FIG. 2 illustrates an exemplary coupon object that may be configured by a retailer and used within a point of sale online coupon processing and tracking system in accordance with the described embodiments;

FIGS. 3A, 3B, and 3C illustrate exemplary tables that may be stored within a data warehouse to manage and sort coupon, retailer, and customer data in accordance with the described embodiments;

FIG. 4 illustrates an exemplary block diagram of a flow chart for one embodiment of a method for managing and tracking digital coupons in a point of sale online coupon processing and tracking system in accordance with the described embodiments; and

FIGS. 5A, 5B, 5C, 5D, and 5E illustrate an exemplary web-enabled personal computing device at various stages of the method for managing and tracking digital coupons in a point of sale online coupon processing and tracking system, in accordance with the described embodiments.

### DETAILED DESCRIPTION

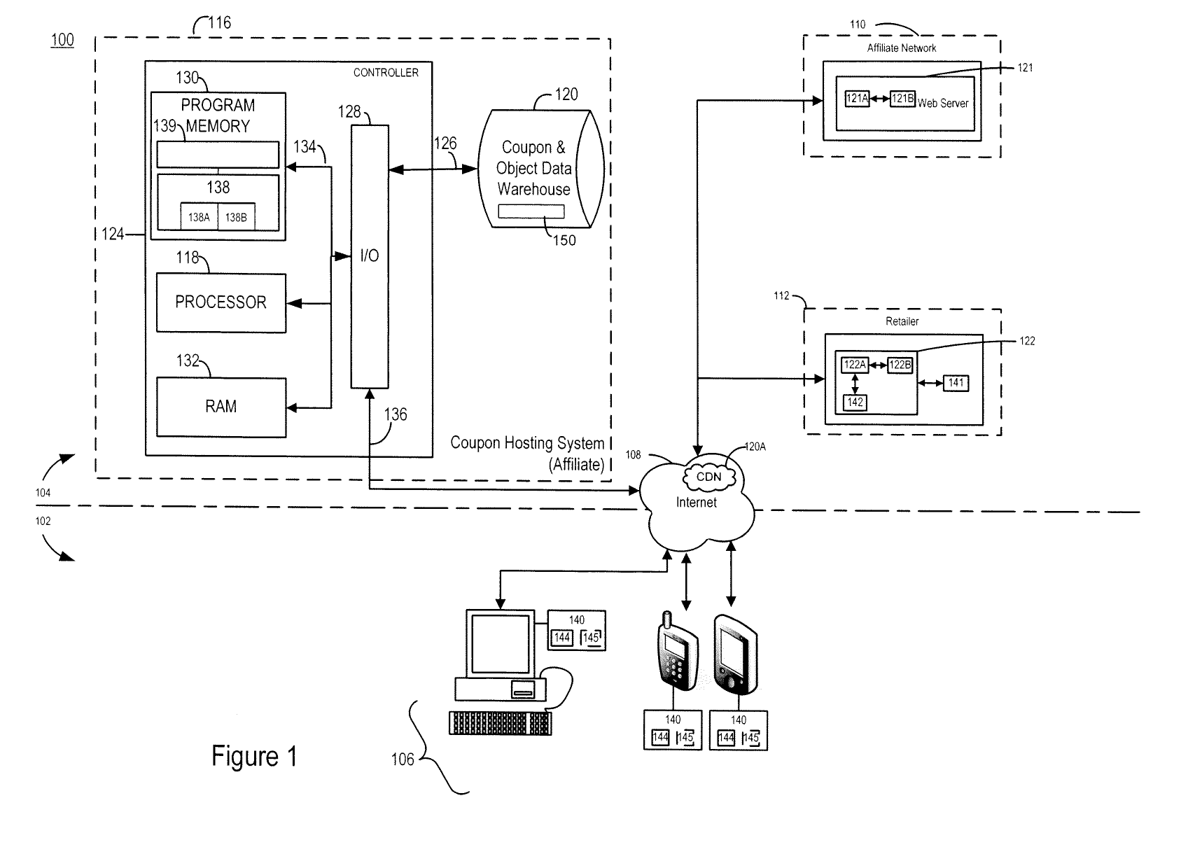

FIG. 1 illustrates various aspects of an exemplary architecture implementing an online system 100 and method for processing and tracking coupons that are displayed online or downloaded to a personal computing device in a point of sale environment. In particular, FIG. 1 illustrates a block diagram of the exemplary point of sale online coupon processing and tracking system 100. The high-level architecture includes both hardware and software applications, as well as various data communications channels for communicating data between the various hardware and software components. The point of sale online coupon processing and tracking system 100 may be roughly divided into front-end components 102 and back-end components 104.

The front-end components 102 are primarily personal web-enabled devices 106 (personal computers, smart phones, PDAs, etc.) connected to the internet 108 by one or more customers. The web-enabled devices 106 may be located, by way of example rather than limitation, in separate geographic locations from each other, including different areas of the same city, different cities, or even different states. The front-end components 102 communicate with the back-end components 104 via the Internet or other digital network 108. In some embodiments, the web-enabled devices 106 may communicate with the back-end components via the Internet 108 and a wireless, wired, or any other connection. The digital network 108 may be a proprietary network, a secure public Internet, a LAN, a virtual private network or some other type of network, such as dedicated access lines, plain ordinary telephone lines, satellite links, combinations of these, etc. Where the digital network 108 comprises the Internet, data communication may take place over the digital network 108 via an Internet communication protocol.

In one embodiment, the back-end components 104 include a coupon hosting system 116 or “affiliate” such as CouponCabin.com or other internet-based, publicly-accessible system, and a retailer 112. In some embodiments, the system 100 also includes an affiliate network 110. Additionally or alternatively, the coupon hosting system 116 may be web server in communication with a private or secure LAN. The coupon hosting system 116 may include one or more computer processors 118 adapted and configured to execute various software applications, modules, functions, routines, and components of the point of sale online coupon processing and tracking system 100.

These various applications, etc., may, in addition to other software applications, allow the retailer 112 to process and track online coupons in a point of sale environment, as further described below. The coupon hosting system or web server 116 further includes a data warehouse or database 120. The data warehouse 120 is adapted to store retailer coupons, coupon codes, discount uniform resource locators (URLs), and other content to be hosted by the coupon hosting system 116 and displayed on a website 139 or other document delivered to a customer's network-enabled device 106. The data warehouse 120 may also be configured to store customer and retailer information within a data structure 150 for use in registering customers, registering retailers, and distributing coupons, as herein described. Some examples of data structures include a linked data structure, an abstract data structure, a concurrent data structure, an array, a list, a queue, a tree, a hash table, a graph, and a database, to name only a few. The coupon hosting system 116 may access data stored in the data warehouse 120 when executing various functions and tasks associated with the operation of the point of sale online coupon processing and tracking system 100, as described herein.

Although the point of sale online coupon processing and tracking system 100 is shown to include a coupon hosting system 116 in communication with three web enabled devices 106, an affiliate network 110, and a retailer 112, it should be understood that different numbers of processing systems, computers, customers, and affiliate networks may be utilized. For example, the Internet 108 may interconnect the system 100 to a plurality of coupon hosting systems, other affiliate networks 110 and retailers 112, and a vast number of web-enabled devices 106. According to the disclosed example, this configuration may provide several advantages, such as, for example, enabling near real-time updates of coupon codes from the system 100 via the retailers 112, changes to the discount links or coupons from the retailers 112, as well as periodic uploads and downloads of information.

The system 100 may also include one or more web servers 121, 122, when the system 100 is configured to employ an affiliate network. These server 121, 122 may each include a controller similar to the controller 124 described above with similar functionality and including data and objects to host a website (e.g., retailer's website 142, coupon hosting website 139, etc.). All servers may further include a display and a keyboard as well as a variety of other input/output devices (not shown) such as a scanner, printer, mouse, touch screen, track pad, track ball, isopoint, voice recognition system, digital camera, etc.

The affiliate network web server 121 may include information, applications, modules, routines, instructions, etc., to register one or more customers and their network-enabled devices to receive an online coupon and identify the coupon hosting system 116 (i.e., the affiliate) in addition to facilitating communication between the web-enabled devices 106 and the coupon hosting system 116.

The retailer 112 may also include a web server 122 including information, applications, modules, routines, instructions, graphics, objects, etc., to facilitate a point of sale transaction that includes a coupon displayed on a personal network-enabled computing device 106, as further explained herein.

Each web server 121, 122 may be a computing apparatus that includes a memory 121A, 122 to store the information, applications, etc., and a processor or controller 121B, 122B to execute the various applications, routines, modules, instructions, etc., as also described herein. The retailer 112 may also be configured as a personal computing device, rather than a server 122. The retailer 112 may use a personal computing device to access the coupon hosting system 116 to configure and submit an online coupon for use by the coupon hosting system 116. This submitted coupon may then be downloaded by a customer's personal network-enabled device 106 for use in a point of sale transaction, as described herein.

The coupon hosting system 116 depicted in FIG. 1 may include a controller 124 operatively connected to the data warehouse 120 via a link 126 connected to an input/output (I/O) circuit 128. It should be noted that, while not shown, additional databases or data warehouses may be linked to the controller 124 in a known manner. The controller 124 includes a program memory 130, the processor 118 (may be called a microcontroller or a microprocessor), a random-access memory (RAM) 132, and the input/output (I/O) circuit 128, all of which are interconnected via an address/data bus 134. It should be appreciated that although only one microprocessor 118 is shown, the controller 124 may include multiple microprocessors 118. Similarly, the memory of the controller 124 may include multiple RAMs 132 and multiple program memories 130. Although the I/O circuit 128 is shown as a single block, it should be appreciated that the I/O circuit 128 may include a number of different types of I/O circuits. The RAM(s) 132 and the program memories 130 may be implemented as a computer-readable storage memory such as one or more semiconductor memories, magnetically readable memories, and/or optically readable memories, for example. A link 136 may operatively connect the controller 124 to the Internet 108 through the I/O circuit 128.

Each personal network-enabled device 106 and the retailer 112 may also include or be operatively connected to a removable, non-volatile memory device to access computer-readable storage memories. The non-volatile memory device may include an optical or magnetic disc reader, USB or other serial device ports, and other access to computer-readable storage memories. In some embodiments, methods, modules, instructions, etc., described herein may be stored on a computer-readable memory that is accessible by or a component of the coupon hosting system 116, the retailer 112, and the personal devices 106 so that the methods, modules, instructions, etc., may be temporarily transferred to the program memory 130 and controllers 124 for execution, as described herein.

The coupon hosting system 116 may have various different structures and methods of operation. It should also be understood that while the embodiment shown in FIG. 1 illustrates some of the components and data connections that may be present in a coupon hosting system 116, it does not illustrate all of the data connections that may be present. For exemplary purposes, one design of a coupon hosting system 116 is described herein, but it should be understood that numerous other designs may be utilized.

The program memory 130 may contain coupon hosting system 116 data and objects 138A and 138B that may be displayed within a coupon hosting website 139 on a web-enabled computing device 106. The data and objects 138A and 138B may be stored in a variety of structures or areas within the front end 102 or back end 104 of the system 100. For example, the data and objects 138A and 138B may be stored within the coupon and object data warehouse 120, the content delivery network 120A, a remote data storage facility, etc.

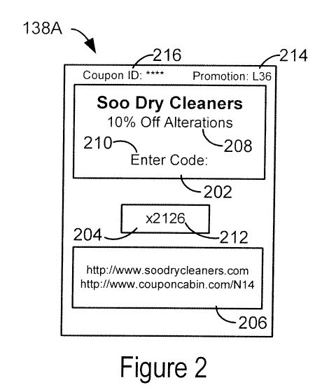

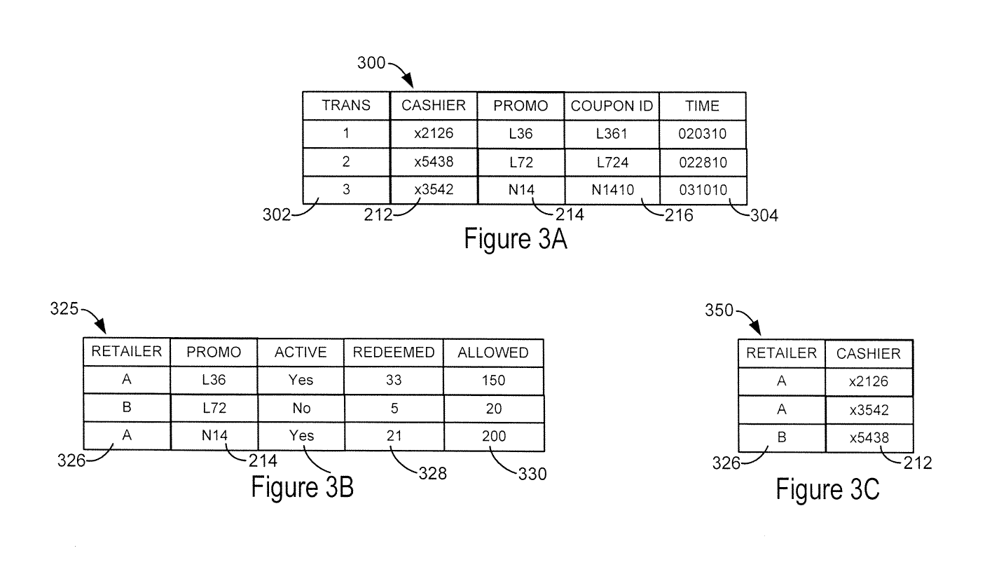

With reference to FIGS. 2 and 3 various examples of data and objects 138 may be used by the system 100. The objects 138 may include client-side computer code such as JavaScript (i.e., “scripts”), code implementing Ajax techniques, web documents such as an XML document, .pdf document, or other types of code for facilitating the methods described herein.

As illustrated by FIG. 2, one example of a coupon hosting system object 138 may include a coupon object 138A. A coupon object 138A may be configured by a retailer or other user with a client-side application, a remote, web-based application hosted by the coupon hosting system 116, or other system. The coupon object 138A may include a text portion 202, a clickable object 204, and one or more hypertext links 206. The text portion 202 may include, among other things, a description of the discount 208 and instructions 210 for the retailer to verify the coupon using the clickable object 204. The hypertext link 206 may be associated with a portion of the text 202 and include instructions to cause the personal device 106 to send a web request to a retailer website 142, the coupon hosting system 116, or other web server. The web request may cause a retailer website or other document to be delivered to the personal device 106 using Http or other web-based protocols.

The clickable object 204 may include one or more instructions to cause the personal device 106 that is currently displaying the coupon object 138A to communicate information from the device 106 to the coupon hosting system 116 after the clickable object 204 is selected. For example, in some embodiments, the clickable object 204 may include a text box or other area to permit a cashier, sales associate, or other retailer representative personnel at the point of sale to enter a code, a password, or other information 212 into the area. The information 212 may include a cashier code 212, as further described herein. In some embodiments, the personal device 106 includes an alphanumeric keypad, bar code scanner, camera, or any other input device that may be used by the cashier to enter the code 212. The code 212 may be communicated to the coupon hosting system 116 (via a web protocol command, e.g., an Http: or similar command), verified as authentic, and stored in a data warehouse 120 as a record that the discount was given to a customer during a point of sale transaction. In some embodiments, the clickable object 204 includes instructions to send a variety of information about the coupon object 138A, the personal computing device 106, the customer, etc., to the coupon hosting system 166. For example, information may include the coupon code 212 and a promotional code 214 that generally identifies the coupon campaign as managed by the retailer 112 and that includes the discount 208 as represented by the coupon object 138A, etc. The information may also identify the specific copy of the coupon object 138A that was used in the transaction (i.e., a coupon ID 216), identify the owner of the personal device 106 that sends the information 212, a physical or network address of the device 106, etc. In some embodiments, a retailer 112 may configure a coupon 138A using the website 139 of the coupon hosting system 116. A coupon 138A may include a text portion 202, a clickable object 204, a hypertext links 206, a discount 208, instructions 210 for the retailer to verify the coupon using the clickable object 204, etc. During configuration, the retailer 112 may assign a promotional code 214 to the coupon 138A. In use, the coupon hosting system 116 may assign a coupon ID 216 to each particular coupon object 138A that is sent from the system 116 to a customer.

With reference to FIG. 3A, the data warehouse 120 of the coupon hosting system 116 may include a first relational table 300 to organize the information 212 within the data warehouse 120. In some embodiments, the data sent to the data warehouse 120 using instructions of the clickable object 138A and other instructions may include one or more of a transaction code 302, cashier code 212, a promotion code 214, a coupon ID 216, a time 304 of the transaction that used the promotion code 214, and other information related to the point of sale transaction and the application of the discount 208 represented by the coupon object 138A. The transaction code 302 may identify a particular point of sale transaction. The cashier code 212 may identify a particular individual, equipment (e.g., a register, computer, etc.) or other entity of the retailer 112. The promotion code 214 may be used to identify the promotion associated with the coupon object 138A as described in the discount portion 208 of the object 138A. The coupon ID 216 may be used to identify a specific coupon 138A that was used in a point of sale transaction so that each coupon 138A sent to a customer may only be used once. The time 304 may identify when the point of sale transaction 302 occurred. The coupon hosting system 116 may also arrange the first relational table 300 so that the cashier code 212 is associated with or related to one or more of the transaction 302, the promotional code 214, and the time 304. In one embodiment, the first relational table 300 organizes at least a cashier code 212 and promotional code 214.

With reference to FIG. 3B, the data warehouse 120 of the coupon hosting system 116 may also include a second relational table 325 to organize further information within the data warehouse 120. In some embodiments, the second table 325 includes data stored in the data warehouse 120 during configuration of a coupon object 138A. For example, a retailer 112 may access and register with a website 139 or other interface of the coupon hosting system 116. The retailer 112 may then configure one or more coupon objects 138A to provide various discounts for the retailer's customers. The second table 325 may then record information to relate each created coupon object 138A with the retailer 112 that created it. The second table 325 may organize various data of the coupon object 138A including: a retailer identifier 326, a promotional code 214 corresponding to a coupon object 138A created by the retailer 112 that is identified by the retailer identifier 326, a flag 328 indicating whether or not the retailer 112 wants a particular coupon 138A associated with the promotional code 214 to be active or not, a number of times the a coupon 138A associated with the promotional code 214 has been redeemed 328, and a threshold number of times the a coupon 138A associated with the promotional code 214 is allowed 330 to be redeemed.

With reference to FIG. 3C, the data warehouse 120 of the coupon hosting system 116 may also include a third relational table 350 to organize further information within the data warehouse 120. In some embodiments, the third table 350 includes data sent to the data warehouse 120 during configuration of a retailer's account with the coupon hosting system 116. For example, a retailer 112 may access and register with a website 139 of the coupon hosting system 116. The retailer may then register one or more cashiers 212 that are authorized to accept online coupons 138A in a point of sale transaction. A cashier code 212 may correspond to an individual employed by the retailer, a piece of equipment used during a point of sale transaction, or other code that could be used by the retailer to verify that the coupon 138A was used in the transaction. In another embodiment, the retailer 112 may register a single cashier code so that all employees that know the code may verify coupons 138A in a point of sale transaction. The third table 350 may then record information to relate at least each retailer code 326 with a valid cashier code 212.

While the data and objects 138 of the coupon hosting system (affiliate) website 139 are depicted in FIGS. 1, 2, 3A, 3B, and 3C as including one object 138A, the data and objects may include any number of objects to produce a coupon hosting system 116 generally and, in particular, the point of sale online coupon processing and tracking system 100, as described herein. Further, while FIG. 1 depicts the object 138 and website 139 as being stored in a program memory 130, the objects 138 and website 139 may be stored apart from the program memory 130, the system 116, or as part of a content delivery network 120A located at various points in the network 108.

By way of example and not limitation, the coupon hosting system data and objects 138, or the object 138A may also include one or more applications, modules, routines, instructions, data, etc., to do one or more of the following: register a retailer with the coupon hosting system 116; register a customer with the coupon hosting system 116; configure or receive and store a coupon object 138A; send the coupon object 138A to be displayed on a personal web-enabled device 106; call a function to send or transmit the coupon object 138A to a personal web-enabled device 106; during a point of sale transaction, call a function to receive and/or forward data including a cashier code 212 and promotion code 214 from the device 106 to the coupon hosting system 116; store the information 212 received from the device 106; display the information 212 from a plurality of point of sale transactions, etc. Using the data 212, 225, etc., and objects 138, the coupon hosting system 116 may execute one or more of the various instructions of the methods described herein with reference to the remaining Figures.

Various software applications and functions resident in the front-end components 102 and the back-end components 104 implement the point-of-sale coupon management methods, implement functions called by the clickable object 138A, and provide various customer and retailer interface methods to allow customers, retailers, and other parties to point-of-sale transactions to access and use the system 100. One or more of the front-end components 102 and/or the back-end components 104 (e.g., the coupon hosting system 116) may include various video, image, and graphic design applications to permit the implementation of a coupon hosting website 139, a retailer website 142, and to facilitate creation of a coupon object 138A.

Each web-enabled device 106 may also include a customer interface application (i.e., a web browser client 140) for accessing the coupon hosting system 116 and retailer 112, generally, and the coupon hosting website 139 and/or the retailer website 142, in particular. The retailer 112 may also include a web browser client 141. In some embodiments, the web browser client 140, 141 is an Internet Explorer® web browser (produced by Microsoft Corporation of Redmond, Wash.) or the Firefox® web browser (produced by the Mozilla Foundation of Mountain View, Calif.) to name only a few possible web browsers. The browser(s) 140, 141 may be any type of web browsing client, including a proprietary client, and may communicate with the various servers 121, 122 and the coupon hosting system 116 using any type of protocol including, but not limited to, file transfer protocol (FTP), telnet, hypertext-transfer protocol (HTTP), etc.

Where the point of sale online coupon processing and tracking system 100 is configured for communication with an affiliate marketing system (e.g., affiliate 110), each browser may also include or have access to one or more cookies 144, 145 to be set before an affiliate receives credit for directing a customer to a retailer's coupon 138A to display or download the coupon for a point-of-sale transaction. The information sent to and from the servers 121, 122 and/or the coupon hosting system 116 may include data retrieved from the data warehouse 120, content delivery network (CDN) 120A, and/or program memories 121A, 121B. The coupon hosting system 116 and/or the servers 121, 122 may implement any known protocol compatible with the website 139 accessed by the web-enabled devices 106 and adapted to the purpose of processing and tracking online coupons in a point-of-sale transaction.

The coupon and object data warehouse 120, the CDN 120A, and program memories 121A, 121B, may include graphics, text, and objects 138 for display within a coupon hosting system website 139, as described herein. For example, graphics may be provided by the system 100 for use within any portion of a website, URLs or other links 206 to retailer websites 142, JavaScript browser objects (e.g., buttons, etc.) or other interactive objects that, when activated by a customer, may display other resources such as online coupons or may perform any of the methods and functions described herein. As generally known in the art, the buttons may include text (some of which may serve as links and URLs to additional information and other websites), data entry boxes or text fields, pull-down lists, radio buttons, check boxes, and images. Throughout this specification, it is assumed that the buttons and clickable objects 138A refer to graphic elements for display within a webpage that are associated with functions executed by a processor. The functions of the clickable objects may be called, activated, or instantiated by a customer using a mouse or other pointing device. Thus, throughout the specification, the terms “click” and “clicking” may be used interchangeably with the terms “select,” “activate,” or “submit” to indicate the selection or activation of one of the functions associated with the display elements. Of course, other methods (e.g., keystrokes, voice commands, etc.) may also be used to select or activate the functions associated with the various objects, function blocks, etc. Moreover, throughout this specification, the terms “link” and “button” are used interchangeably to refer to a graphic representation of a command that may call a method, function, or function block (i.e., the various “block #” as described below) including one or more instructions that are stored in a volatile or non-volatile computer-readable memory and executed by a processor or controller by clicking on the graphic representation.

The methods for processing and tracking online coupons in a point-of-sale transaction may include one or more functions that may be stored as computer-readable instructions on a computer-readable storage medium, such as a program memory 130, or optical, magnetic, or flash memory, and may include the objects 138 and clickable objects 138A as described herein. The instructions are generally described below as “blocks” or “function blocks” proceeding as illustrated in the flowcharts described herein. While the blocks of the flowcharts are numerically ordered and described below as proceeding or executing in order, the blocks may be executed in any order that would result in processing and tracking online coupons in a point-of-sale transaction, as described herein.

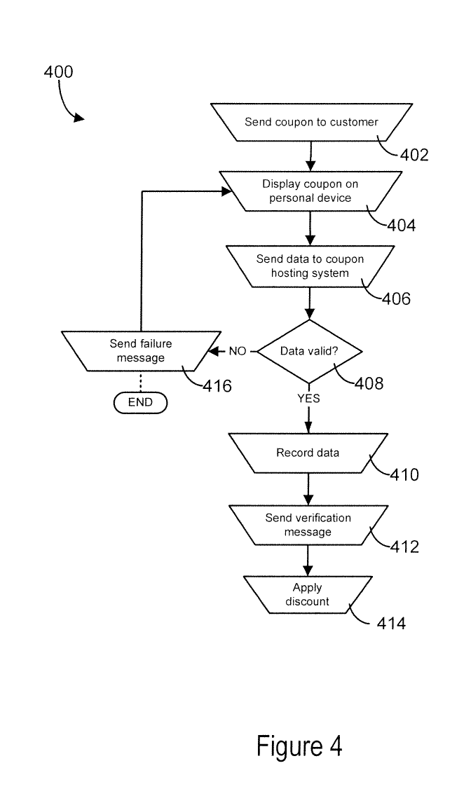

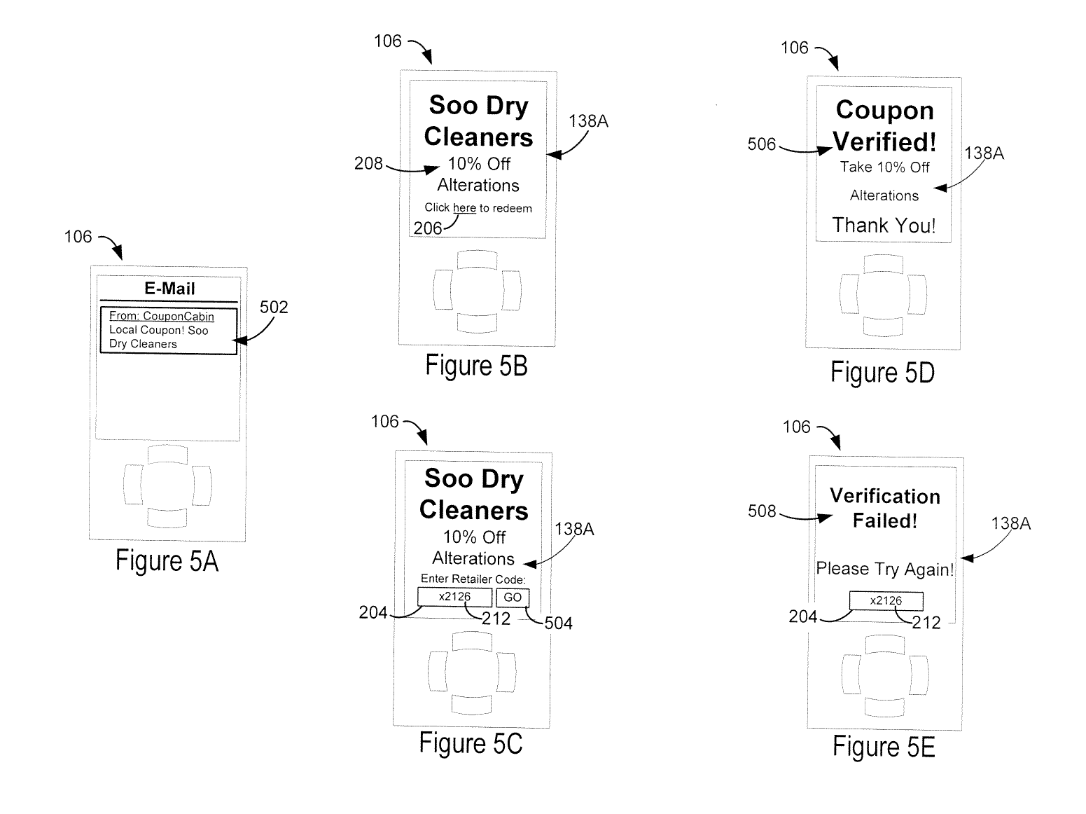

FIG. 4 illustrates one embodiment of a method 400 for processing and tracking coupons downloaded by a customer and displayed on the customer's personal computing device 106 to a retailer 112 during a point-of-sale transaction. FIGS. 5A-5E illustrate one embodiment of a customer's personal computing device 106 during implementation of the method 400 during a point of sale transaction. At block 402 (FIG. 4), the coupon hosting system 116 may send a coupon message 502 (FIG. 5A) to a customer. In some embodiments, the system 116 may send an email message a customer's e-mail address after the customer has registered at the system website 139. A customer's registration at the website 139 may include identifying information such as an e-mail address, phone number, etc. The system 116 may then use the identifying information to send a hyperlink to the customer. The hyperlink may facilitate displaying a webpage, accessing a document, downloading a file of the coupon 138A, etc., or may send the coupon 138A object itself. Further, the customer's registration may include various preferences associated with the coupons 138A. For example, the customer may indicate a preference that the system 116 send coupons 138A based on other information the customer provides during registration (e.g., coupons for local retailers based on the customer's zip code, address, area code, birthday, activities and hobbies, favorite retailers, etc.), or other preferences.

At block 404, the customer may select the coupon message 502 to display the coupon 138A on the customer's personal device 106 (FIG. 5B). For example, the customer may select a hyperlink object from an e-mail 502 (FIG. 5A) received from the system 116 that, upon selection, sends a web request to the system 116. The web request may include commands to access and download an object 138 or functions from the data warehouse 120 including a coupon 138A. Whether downloaded from the system 116 or accessed via an e-mail link, the coupon 138A may be sent from the system 116 to be displayed on the personal device 106. The coupon object 138A displayed on the device 106 may include various portions including a discount portion 208 and a hyperlink portion 206.

At block 406, selection of the hypertext portion 206 may cause the personal computing device 106 to display an object (e.g., the coupon object 138A of FIG. 5C) that allows a retailer to send verification data corresponding to the displayed coupon 138A that is received by the back end (e.g., the coupon hosting system 116). In some embodiments, the displayed coupon object 138A includes a clickable object 204 that permits a retailer to enter a cashier code 212 or other code (e.g., a text box object 204). The coupon 138A may also include another clickable object 504 that, upon selection, calls a function to send one or more of the cashier code 212, the promotion code 214, and the coupon ID 216 (FIG. 2) of the coupon object 138A displayed on the customer's personal device 106 to the back end 104 (e.g., the coupon hosting system 116). At the back end 104, the system 116 may receive one or more of the promotion code 214, the cashier code 212, and the coupon ID 216 from the personal computing device 106. The system 116 may receive the data sent from the customer's personal computing device 106 via the internet 108 or other network through the data link 136.

At block 408, the coupon hosting system 116 may validate the received data to determine that the displayed coupon object 138A is valid and to determine that the received cashier code 212 has been registered by the retailer 112. In some embodiments, a verification module 138B of the coupon hosting system 116 may include instructions stored in computer-readable memory and executed by a processor to compare one or more of the received promotion code 214, the cashier code 212, and the coupon ID 216 to the registered coupon and retailer data within one or more database tables (e.g., tables 300, 325, and 350 of FIGS. 3A, 3B, and 3C) that are stored within the data warehouse 120. In some embodiments, a verification module 138B may include a function or instructions to compare a received cashier code 212 to data within the third table 350 to determine if a retailer 326 has registered that particular cashier code 212. Alternatively or additionally, after determining that the received cashier code 212 has been registered, a verification module 138B may compare the retailer code 326 corresponding to the received cashier code 212 in the third table 350 and the coupon ID 216 to data in the second relational table 325 to determine if the coupon 138A is valid. For example, the verification module 138B may compare the retailer code 326, the received cashier code 212, the coupon ID 216, and a validation flag 328 to determine if the coupon 138A is valid. Further, the verification module 138B may increment a number of times a coupon 138A associated with the promotion code 214 has been redeemed 328 and compare that number with a threshold number of times the promotion code 214 is allowed to be redeemed 330.

In some embodiments, a verification module 138B may compare data within the tables 350, 325, and 300 using instructions stored in a computer-readable memory (120, 130) and executed by a component of the back end 104 (e.g., the coupon hosting system 116) to: a) compare a received cashier code 212 to a retailer ID 326 to determine if the retailer 112 has registered the received cashier code 212. If yes, then the verification module 138B may b) compare the retailer ID 326 associated with the registered cashier code 212 to coupon IDs 216 associated with that retailer ID 326 to determine if the retailer 112 has registered a coupon 138A corresponding to a received coupon ID 216. If yes, then c) compare the registered coupon ID 216 to a corresponding flag 328 to determine if the registered coupon ID 216 is valid or active. If valid and active, then d) compare an incremented number of times a coupon 138A associated with the promotion code 214 has been redeemed 328 with a threshold number of times the promotion code 214 is allowed to be redeemed 330. One or more of the steps described above may be performed to validate a received coupon object 138A.

If the steps of block 408 succeed, then the coupon 138A is valid and the coupon hosting system 116 or other back end 104 component may record the data sent by the personal computing device 106 at block 410. In some embodiments, block 410 may record the received data within the first relational table 300 (FIG. 3A). The data recorded at block 410 may include the received cashier code 212, the received promotion code 214, and the received coupon ID 216. Additionally, block 410 may record a time associated with the point of sale transaction 304 and a transaction number 302. Block 412 may send a validation message 506 (FIG. 5D) that is then displayed on the customer's personal computing device 106.

Upon validation of the coupon 138A, the retailer 112 may apply the discount 208 to the point of sale transaction at block 414. In some embodiments, the retailer may include a web-enabled computing device (i.e., a cash register, personal computer, or other computing device used in calculation of the final price of the point of sale transaction). The retailer's web enabled computing device may also be in communication with the coupon hosting system 116. Upon verification of the coupon 138A, the coupon hosting system 116 may send a message or instructions to the retailer 112 to apply the discount 208. Using the message or instructions, the discount 208 may be automatically applied to the transaction through the retailer's web-enabled computing device. In other embodiments, a cashier manually applies the discount.

If the steps of block 408 fail, then the coupon 138A is invalid and the coupon 138A is invalid and the coupon hosting system 116 or other back end 104 component may send a failure message 508 (FIG. 5E) that is then displayed on the customer's personal computing device 106. The method 400 may then return to block 404 so that the retailer 112 may re-enter a cashier code 212 within a text box 204 and conduct another attempt to validate the coupon 138A, or end the method 400.

With reference to FIGS. 1-5, a typical transaction using the system 100 and method 400 described above may proceed generally as follows. Alice, a customer of Soo Dry Cleaners, finds a coupon 138A displaying a discount 208 embedded in an e-mail that she retrieved using her personal computing device 106 (e.g., smart phone). Alice goes to Soo Dry Cleaners and presents her personal computing device 106 that displays the coupon 138A. A button displayed on the coupon 138A may instruct the cashier to “click here to redeem.” Alice or the cashier may select this button and be presented with a second screen asking the cashier to enter a cashier code 212 within a text box 204 and select a button 504 to send the code 212 and other information (e.g., a coupon ID 216, promotion ID 214, device type, time, other information currently stored within Alice's personal computing device 106, etc.) to the back end 104 (i.e., the coupon hosting system 116). If the coupon is valid, the cashier may apply the discount 208 in a point of sale transaction. If the coupon is invalid, the cashier may attempt to re-validate the coupon 138A, or quit the process.

Soo, the manager of Soo Dry Cleaners, may later log in to a website 139 of the coupon hosting system 116 to find a report including data stored within the data warehouse 120 (e.g., the tables 300, 325, 350, etc.). Soo now has a digital trail of which coupons were redeemed, when the redemption occurred, and who of her cashiers completed the transaction that included the coupon 138A.

This detailed description is to be construed as exemplary only and does not describe every possible embodiment, as describing every possible embodiment would be impractical, if not impossible. One could implement numerous alternate embodiments, using either current technology or technology developed after the filing date of this provisional patent application.

We claim:

1. A digital coupon system configured to manage a discount given to a customer in a point of sale transaction using the customer's web-enabled personal computing device, the system comprising:
a program memory;
a processor;
a coupon object displayed on the personal computing device, the coupon object displaying a text portion and a clickable object, the clickable object including a plurality of instructions stored in the program memory and executed by the processor to send a cashier code to a remote coupon hosting system, the cashier code received by the personal computing device during the point of sale transaction; and
a verification module including a plurality of instructions stored in the program memory and executed by the processor to compare the cashier code to coupon object data stored in a data warehouse of the coupon hosting system;
wherein the cashier code matching the coupon object data causes the coupon hosting system to send a validation message for display on the personal computing device.

2. The system of claim 1, wherein the coupon object includes a promotional code identifying a coupon campaign of the coupon object, a coupon ID identifying the coupon object, and a discount.

3. The system of claim 2, wherein the coupon object includes further instructions to send one or more of the promotional code and the coupon ID to the coupon hosting system.

4. The system of claim 3, wherein the verification module includes further instructions to compare one or more of the promotional code and the coupon ID to the coupon object data stored in the data warehouse of the coupon hosting system.

5. The system of claim 1, wherein the coupon hosting system sends the coupon object to the personal computing device.

6. The system of claim 1, wherein the cashier code not matching the coupon object data causes the coupon hosting system to send a failure message for display on the personal computing device.

7. The system of claim 1, wherein the verification module includes further instructions to record one or more of the cashier code, a transaction number, a promotion code, a coupon ID, and a transaction time at the coupon hosting system.

8. The system of claim 1, wherein the validation message includes instructions executed by the processor to automatically apply a discount to the point of sale transaction.

9. A method for managing a discount given to a customer in a point of sale transaction using the customer's web-enabled personal computing device, the method comprising:
sending a coupon object for display on a personal computing device, the coupon object displaying a text portion and a clickable object;
sending a cashier code from the personal computing device to a remote coupon hosting system using the clickable object, the cashier code received by the personal computing device during the point of sale transaction;
comparing the cashier code to coupon object data stored in a data warehouse of the coupon hosting system;
recording the cashier code at the coupon hosting system; and
sending a validation message for display on the personal computing device when the cashier code matches the coupon object data.

10. The method of claim 9, wherein the coupon object includes a promotional code identifying a coupon campaign of the coupon object, a coupon ID identifying the coupon object, and a discount.

11. The method of claim 9, wherein the coupon object includes further instructions to send one or more of the promotional code and the coupon ID to the coupon hosting system.

12. The method of claim 11, further comprising comparing one or more of the promotional code and the coupon ID to the coupon object data stored in the data warehouse of the coupon hosting system.

13. The method of claim 9, wherein the coupon hosting system sends the coupon object to the personal computing device.

14. The method of claim 9, further comprising sending a failure message for display on the personal computing device when the cashier code does not match the coupon object data.

15. The method of claim 9, further comprising recording one or more of the cashier code, a transaction number, a promotion code, a coupon ID, and a transaction time at the coupon hosting system.

16. A computer-readable storage medium comprising computer-executable instructions to manage a discount given to a customer in a point of sale transaction using the customer's web-enabled personal computing device, the instructions to:
send a coupon object from a coupon hosting system to the personal computing device, the coupon object including a promotional code, a coupon ID, and a discount;
display the coupon object on the personal computing device, the coupon object displaying the discount, a text portion, and a clickable object;
receive a cashier code at the personal computing device during the point of sale transaction;
send the cashier code, the promotional code, and the coupon ID from the personal computing device to a remote coupon hosting system using the clickable object;
compare one or more of the cashier code, the promotional code, and the coupon ID to coupon object data stored in a data warehouse of the coupon hosting system;
record the cashier code, the promotional code, and the coupon ID at the coupon hosting system; and
send a validation message for display on the personal computing device when the cashier code matches the coupon object data.

17. The computer-readable storage medium of claim 16, wherein the promotional code identifies a coupon campaign of the coupon object and the coupon ID identifies the coupon object.

18. The computer-readable storage medium of claim 16, further comprising instructions to send a failure message for display on the personal computing device when the cashier code does not match the coupon object data.

19. The computer-readable storage medium of claim 16, further comprising instructions to automatically apply the discount to the point of sale transaction when the validation message is sent.

20. The computer-readable storage medium of claim 16, wherein the validation message includes instructions executed to automatically apply a discount to the point of sale transaction.
